(19) United States
(12) Patent Application Publication
(10) Pub. No.: US 2007/0223260 A1
(43) Pub. Date: Sep. 27, 2007

(54) Power supply device with inrush current control circuit

(75) Inventors: Sin-Shong Wang, Shenzhen (CN); Shun-Chen Yang, Shenzhen (CN); Kuo-Wei Chiang, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,874

(22) Filed: Oct. 17, 2006

(30) Foreign Application Priority Data
Mar. 24, 2006 (TW) 95110331

(51) Int. Cl. H02H 7/125

(52) U.S. Cl. 363/52

(57) ABSTRACT

A power supply device (1) converting received power signals to direct current signals to ensure a load to work normally. The power supply device includes a transformer circuit (10), a rectifier circuit (11), and an inrush current control circuit (12). The transformer circuit converts the received power signals to alternating current signals. The rectifier circuit is connected to the transformer circuit, and converts the alternating current signals to direct current signals. The inrush current control circuit is connected to the rectifier circuit, for limiting inrush current from the power supply device. The inrush current control circuit includes a voltage divider resistor (R1) and a filter capacitor (C1). The filter capacitor is connected to the voltage divider resistor in series. In the invention, the power supply device uses the inrush current control circuit to limit the inrush current, thus life of the components is lengthened, and the power supply device is stable.

### FIELD OF THE INVENTION

The present invention relates to power supply devices, and particularly to a power supply device with an inrush current control circuit.

### DESCRIPTION OF RELATED ART

Generally, with the development of technologies, network devices, such as asymmetrical digital subscriber loop (ADSL) modems, cable modems, and set-top boxes are widely used. Each of the network devices has a power supply device, for converting an alternating current voltage (for example, 220V in china, and 110V in USA) to an appropriate direct current to ensure normal operation of the network devices. However, when the power supply device is initially powered on, an inrush current is generated due to a capacitor effect. Peak value of the inrush current can damage components, such as fuses, switches, so that life of the components is shortened accordingly.

### SUMMARY OF THE INVENTION

The present invention provides a power supply device converting received power signals to direct current signals to a load. The power supply device includes a transformer circuit, a rectifier circuit, and an inrush current control circuit. The transformer circuit converts the received power signals to alternating current signals. The rectifier circuit is connected to the transformer circuit, and converts the alternating current signals to direct current signals. The inrush current control circuit is connected to the rectifier circuit, for limiting inrush current from the power supply device. The inrush current control circuit includes a voltage divider resistor and a filter capacitor. The filter capacitor is connected to the voltage divider resistor in series.

Other advantages and novel features will become more apparent from the following detailed description when taken in conjunction with the accompanying drawings, in which:

### BRIEF DESCRIPTION OF THE DRAWINGS

FIG. 1 is a block diagram of a power supply device of an exemplary embodiment of the present invention;

FIG. 2 is a detail circuit diagram of FIG. 1 of the present invention; and

FIG. 3 is a waveform diagram of a power supply device of FIG. 2.

### DETAILED DESCRIPTION OF THE INVENTION

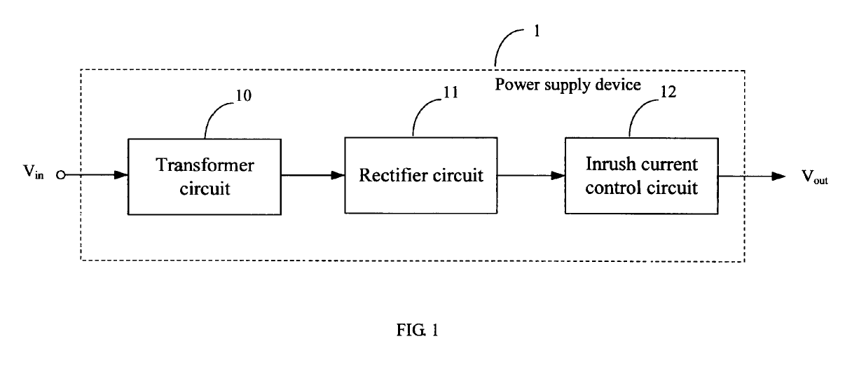

FIG. 1 is a block diagram of a power supply device 1 of an exemplary embodiment of the present invention. The power supply device 1 includes a transformer circuit 10, a rectifier circuit 11, and an inrush current control circuit 12.

The transformer circuit 10 converts received power signals Vin from a power source to alternating current (AC) signals. In the exemplary embodiment, the power signals Vin are sine-wave signals Vin output from an AC power source (for example, 220V in china, or 110V in USA, not shown in FIG. 1). The rectifier circuit 11 is connected to the transformer circuit 10, and converts the AC signals output from the transformer circuit 10 to direct current (DC) signals. In the exemplary embodiment, the DC signals are ripple signals. The inrush current control circuit 12 is connected to the rectifier circuit 11, for limiting inrush current from the power supply device 1 and filtering ripple from the DC signals, and outputting smooth DC signals Vout to a load. In the exemplary embodiment, the load can be an ADSL modem, a cable modem, a set-up box, and so on.

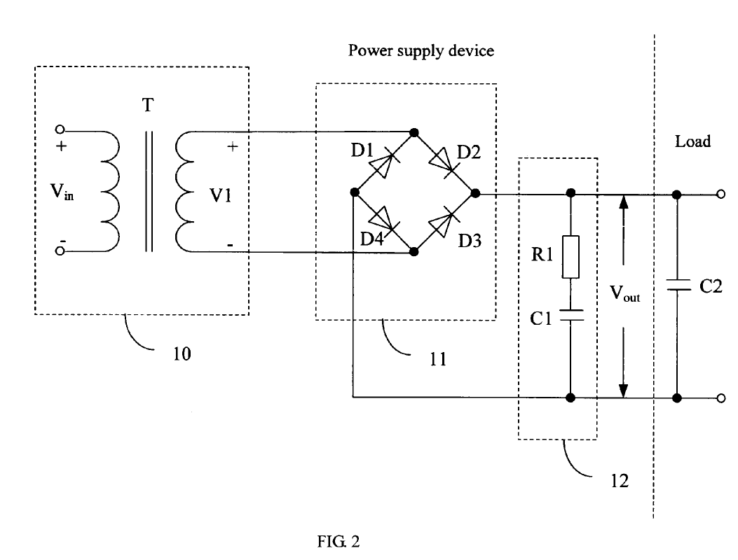

FIG. 2 is a detail circuit diagram of FIG. 1 of the present invention. The transformer circuit 10 includes a transformer T. The transformer T includes a primary winding and a secondary winding. The primary winding is defined as an input of the power supply device 1, for receiving the sine-wave signals Vin from the AC power source. The secondary winding is connected to the rectifier circuit 11. In the exemplary embodiment, a coil number of the secondary winding of the transformer T is less than that of the primary winding. When the primary winding receives the sine-wave signals Vin from the AC power source, a magnetic field produced also covers the secondary winding, so that low voltage AC signals V1 are produced across the secondary winding, and the low voltage AC signals V1 are output to the rectifier circuit 11.

The rectifier circuit 11 as shown in FIG. 2 is a full-bridge rectifier circuit. The rectifier circuit 11 includes a plurality of diodes D1, D2, D3, and D4. A cathode of the diode D1 and an anode of the diode D2 are jointly connected to a high voltage terminal of the secondary winding of the transformer T. An anode of the diode D3 and a cathode of the diode D4 are jointly connected to a low voltage terminal of the secondary winding of the transformer T. A cathode of the diode D2 is connected to a cathode of the diode D3, and an anode of the diode D1 is connected to an anode of the diode D4. Therefore, the diodes D1, D2, D3, and D4 form the full-bridge rectifier circuit. In the exemplary embodiment, the rectifier circuit 11 converts the low voltage AC signals V1 output from the transformer circuit 10 to the DC signals, and outputs the DC signals to the inrush current control circuit 12.

In alternative exemplary embodiments of the present invention, the rectifier circuit 11 can be a half-bridge rectifier circuit. The half-bridge rectifier circuit is generally known and easily replaced with the full-bridge rectifier circuit by anyone skilled in the art, and thus, descriptions and figures thereof are omitted.

The inrush current control circuit 12 is connected to the rectifier circuit 11, for limiting inrush current from the power supply device 1. The inrush current control circuit 12 includes a voltage divider resistor R1 and a filter capacitor C1. The filter capacitor C1 is connected to the voltage divider resistor R1 in series, which are connected between the anode of the diode D1 and the cathode of the diode D2. The inrush current control circuit 12 utilizes a characteristic of the charging and discharging of the filter capacitor C1 to filter ripple from DC signals output to the load. In the exemplary embodiment, the load includes a storage capacitor C2, connected between the anode of the diode D1 and the cathode of the diode D2. Equivalent impedance of the filter capacitor C1 can be increased via the voltage divider resistor R1 in the inrush current control circuit 12, and thus, the inrush current can be controlled and reduced.

In the exemplary embodiment, the filter capacitor C1 discharges to the load according to a formula: i(t)=V/R×e−t/RC (wherein R represents an equivalent impedance of the inrush current control circuit 12.). When t=0, the filter capacitor C1 provides electrical energy to the storage capacitor C2 of the load initially, i(0)=V/R. Without the voltage divider resistor R1, R is equivalent to impedance of the filter capacitor C1. The equivalent impedance of the filter capacitor C1 is small, so that it can be omitted. Consequently, current i(0) flowing through the power supply device 1 is essentially infinite, which is inrush current. With the voltage divider resistor R1, the resistor R value is a sum of the voltage divider resistor R1 value and equivalent impedance of the filter capacitor C1. Therefore, current flowing to the load is decreased with the increasing value impedance R, which limits the inrush current. In the exemplary embodiment, a range of the resistance of the voltage divider resistor R1 is from 0 to 1.5 ohm.

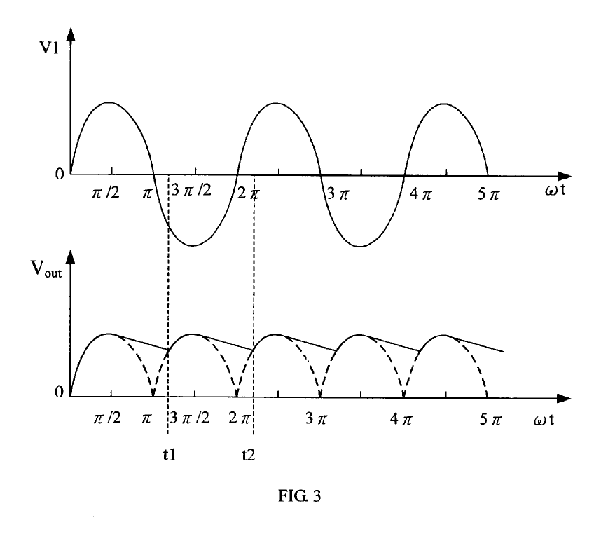

FIG. 3 is a waveform of a power supply device 1 of FIG. 2 over time. V1 is a waveform output voltage of the secondary winding of the transformer T, and Vout is a waveform of output voltage of the inrush current control circuit 12 (internal resistors values of the diodes D1, D2, D3, D4 are omitted.) A dashed curve is a waveform of output voltage of the rectifier circuit 11.

In a time period from 0 and π/2, the diodes D2, D4 of the rectifier circuit 11 are on, the output voltage V1 not only provides electrical energy to the load, but also charges the filter capacitor C1. When the filter capacitor C1 is charged to the time at π/2, the output voltage Vout of the inrush current control circuit 12 is greater than that of the secondary winding. Therefore, the diodes D2, D4 are off, and the filter capacitor C1 starts to discharge to the load.

In a time from π/2 to t1, the filter capacitor C1 discharges slowly. Consequently, the output voltage Vout of the inrush current control circuit 12 is also dropped slowly. In a time from π and t1, the output voltage V1 of the secondary winding is negative, and the absolute value of the output voltage V1 is less than that of the inrush current control circuit 12. Therefore, the diodes D1, D2, D3, and D4 are off.

In a time from t1 to 3π/2, the absolute value of the output voltage V1 of the secondary winding of the transformer T is greater than that of the inrush current control circuit 12, and the diodes D1, D3 in the rectifier circuit 11 are on. The filter capacitor C1 is charged again. When the filter capacitor C1 is charged to the time at 3π/2, the output absolute voltage Vout of the inrush current control circuit 12 is greater than that of the secondary winding of the transformer T. Therefore, the diodes D1, D3 are off, and the filter capacitor C1 starts to discharge to the load.

In a time from 3π/2 to t2, the filter capacitor C1 discharges slowly. Therefore, the output voltage Vout of the inrush current control circuit 12 is also dropped slowly. The diodes D1, D2, D3, D4 are off. When the output absolute voltage Vout of the inrush current control circuit 12 is greater than that of the secondary winding of the transformer T, the diodes D2, D4 are on. Therefore, the filter capacitor C1 is charged. By charging and discharging of the filter capacitor C1 repeatedly, the waveform of the output voltage Vout of the inrush current control circuit 12 is generated.

The inrush current control circuit 12 of the present invention uses the voltage divider resistor R1 to increase equivalent impedance R of the inrush current control circuit 12, which can limit the inrush current. In addition, charging and discharging of the filter capacitor C1 filters ripple from the DC signals output to the load.

While various embodiments and methods of the present invention have been described above, it should be understood that they have been presented by way of example only and not by way of limitation. Thus the breadth and scope of the present invention should not be limited by the above-described exemplary embodiments, but should be defined only in accordance with the following claims and their equivalent.

What is claimed is:

1. A power supply device, for converting received power signals to direct current signals to a load, comprising:
a transformer circuit, for converting the received power signals to alternating current signals;
a rectifier circuit, connected to the transformer circuit, for converting the alternating current signals to direct current signals; and
an inrush current control circuit, connected to the rectifier circuit, for limiting inrush current from the power supply device, comprising:
a voltage divider resistor; and
a filter capacitor, connected to the voltage divider resistor in series.

2. The power supply device as claimed in claim 1, wherein the transformer circuit comprises a transformer comprising a primary winding and a secondary winding; the primary winding is an input of the power supply device for receiving power signals, and the secondary winding is connected to the rectifier circuit.

3. The power supply device as claimed in claim 2, wherein the rectifier circuit comprises:
a first diode;
a second diode, wherein an anode of the second diode and a cathode of the first diode are jointly connected to a high voltage terminal of the secondary winding of the transformer;
a third diode, wherein a cathode of the third diode is connected to a cathode of the second diode; and
a fourth diode, wherein a cathode of the fourth diode and an anode of the third diode are jointly connected to a low voltage terminal of the secondary winding of the transformer, and an anode of the fourth diode is connected to an anode of the first diode.

4. The power supply device as claimed in claim 3, wherein the filter capacitor and the voltage divider resistor are connected between the anode of the first diode and the cathode of the second diode.

5. The power supply device as claim in claim 3, wherein the load comprises a storage capacitor, connected between the anode of the first diode and the cathode of the second diode.

6. The power supply device as claimed in claim 1, wherein the rectifier circuit is a full-bridge rectifier circuit or a half-bridge rectifier circuit.

7. The power supply device as claimed in claim 1, wherein a range of the resistance of the voltage divider resistor is from 0 to 1.5 ohm.

8. A power supply device for powering a load, comprising:
a power source providing power signals;
a transformer circuit electrically connectable with said power source so as to convert said power signals received from said power source to alternating current signals;
a rectifier circuit electrically connectable with said transformer circuit to accept said alternating current signals, and to further convert said alternating current signals to direct current signals;
a capacitor electrically connectable between said rectifier circuit and a load to accept said direct current signals from said rectifier circuit, and to further filter said direct current signals for outputting to said load; and
at least one resistor electrically and serially connectable with said capacitor.

9. The power supply device as claimed in claim 8, wherein said rectifier circuit is a selective one of a full-bridge rectifier circuit and a half-bridge rectifier circuit.

10. A circuit assembly comprising:
a load to be powered;
a power source providing power signals for said load;
a transformer circuit electrically connectable between said power source and said load to convert said power signals from said power source to alternating current signals;
a rectifier circuit electrically connectable between said transformer circuit and said load to convert said alternating current signals from said transformer circuit to direct current signals; and
an inrush current control circuit electrically connectable between said rectifier circuit and said load to filter said direct current signals before said filtered direct current signals are output to said load, said inrush current control circuit comprising at least one resistor to increase equivalent impedance of said inrush current control circuit for outputting.

11. The circuit assembly as claimed in claim 10, wherein said inrush current control circuit comprises a capacitor to filter said direct current signals for outputting, and said at least one resistor is electrically and serially connectable with said capacitor in said inrush current control circuit.
